(19) United States
(12) Patent Application Publication
(10) Pub. No.: US 2018/0073575 A1
(43) Pub. Date: Mar. 15, 2018

(54) CLUTCH WITH WEDGE PLATE SEGMENTS

(71) Applicants: Joshua HIXENBAUGH, Wooster, OH (US); Schaeffler Technologies AG & Co. KG, Herzogenaurach (DE)

(72) Inventor: Joshua Hixenbaugh, Wooster, OH (US)

(21) Appl. No.: 15/565,319

(22) PCT Filed: Oct. 15, 2015
(86) PCT No.: PCT/US2015/055746

§ 371 Date: Oct. 9, 2017

(51) Int. Cl. F16D 41/063; F16D 13/16

(52) U.S. Cl. CPC F16D 41/063; F16D 13/16

(57) ABSTRACT

A wedge clutch, including an inner race including radially outwardly extending ramps, an outer race, wedge plate segments disposed between the inner and outer races. Each wedge plate segment is formed of a separate piece of material and includes at least one radially inwardly extending ramps in contact with at least one radially outwardly extending ramp. Wedge plate segments are aligned in a circumferential direction. For an open or free-wheel mode for the wedge clutch, the wedge plate segments are rotatable with respect to the outer race. To transition from the open or free-wheel mode, to a locked mode for the wedge clutch, the inner race is arranged to receive torque in a first circumferential direction, and circumferentially adjacent wedge plate segments are arranged to displace away from each other in the first or second circumferential directions and radially outward to non-rotatably connect with the inner and outer races.

### CROSS-REFERENCE TO RELATED APPLICATIONS

The present application is the United States National Stage Application pursuant to 35 U.S.C. §371 of International Patent Application No. PCT/US2015/55746, filed Oct. 15, 2015, which application is hereby incorporated by reference in its entirety.

### FIELD

The present invention relates generally to a wedge plate clutch, and, more specifically, to a wedge plate clutch with a wedge plate assembly including multiple separate wedge plate segments.

### BACKGROUND

FIG. 14 is a front view of prior art wedge plate 300 for a bi-directional wedge clutch. As is known in the art, wedge plate 300 is arranged to be radially disposed between an inner race (not shown) and an outer race (not shown). Plate 300 includes portions 302, sprung portions 304 and slots 306. Portions 304 connect adjacent portions 302. Portions 304 and slots 306 are necessary to provide the circumferential and radial expansion and contraction discussed below. Each portion 302 includes radially outermost surface 308, which is typically chamfered, and ramps 310 and 312. Ramps 310 extend radially inward along circumferential direction CD1 and ramps 312 extend radially inward along circumferential direction CD2.

Plate 300 is formed of a resilient material so that plate 300 is biased radially outward. When plate 300 is installed between the inner and outer races, plate 300 is radially contracted and the bias creates frictional contact between surfaces 308 and the outer race. That is, the outer diameter of plate 300 is greater than the inner diameter of the outer race prior to installation of plate 300 in the outer race. The biasing and frictional contact is necessary for operation of a clutch including plate 300 as is known in the art. For example: the biasing is necessary to enable switching between open and closed modes for the clutch; and the resiliency and biasing are necessary to enable plate 300 to circumferentially and radially expand and contract between open and closed modes.

However, in order to obtain the necessary resiliency and biasing, the axial thickness of plate 300 must be limited, which limits the torque-carrying capacity of the wedge plate and the clutch. Further, the spring material needed for the required biasing is relatively expensive. In addition, slots 306, also needed for the expansion and contraction of wedge plate 300, add complexity and cost to the fabrication of plate 300.

### SUMMARY

According to aspects illustrated herein, there is provided a wedge clutch, including an inner race arranged to receive torque and including a plurality of radially outwardly extending ramps, an outer race located radially outward of the inner race, and a plurality of wedge plate segments disposed between the inner and outer races in a radial direction, each wedge plate segment is formed of a separate piece of material and includes at least one radially inwardly extending ramp in contact with at least one respective ramp included in the plurality of radially outwardly extending ramps. Wedge plate segments in the plurality of wedge plate segments are aligned in first and second opposite circumferential directions. For an open mode or a free-wheel mode for the wedge clutch the plurality of wedge plate segments is rotatable with respect to the outer race. To transition from the open or free-wheel mode, to a first locked mode for the wedge clutch, the inner race is arranged to receive torque in a first circumferential direction, and circumferentially adjacent wedge plate segments are arranged to displace away from each other in the first or second circumferential directions and radially outward to non-rotatably connect with the inner and outer races.

According to aspects illustrated herein, there is also provided a wedge clutch, including an inner race arranged to receive torque; an outer race located radially outward of the inner race, a wedge plate assembly including a plurality of wedge plate segments disposed between the inner and outer races in a radial direction, each wedge plate segment formed of a separate piece of material, and an actuation assembly including a plurality of blocking plates non-rotatably connected to the inner race and an actuator. Wedge plate segments in the plurality of wedge plate segments are aligned in first and second opposite circumferential directions. For an open mode or a free-wheel mode for the wedge clutch, the plurality of blocking plates is arranged to limit rotation of the plurality of wedge plate segments with respect to the inner race. For a first locked mode for the wedge clutch, the actuator is arranged to axially displace the plurality of blocking plates in a first axial direction, the plurality of blocking plates is arranged to disengage from the plurality of wedge plate segments, the inner race is arranged to receive torque in a first circumferential direction, circumferentially adjacent wedge plate segments are arranged to displace away from each other in the first or second circumferential directions, and the plurality of wedge plate segments is arranged to displace radially outward to non-rotatably connect with the inner and outer races.

According to aspects illustrated herein, there is also provided a one-way wedge clutch, including an inner race arranged to receive torque and including a plurality of first ramps extending radially outward along a first circumferential direction, an outer race located radially outward of the inner race, and a plurality of wedge plate segments disposed between the inner and outer races in a radial direction. Each wedge plate segment is formed of a separate piece of material and includes a second ramp extending radially inward in a second circumferential direction, opposite the first circumferential direction, and in contact with a respective first ramp. Wedge plate segments in the plurality of wedge plate segments are aligned in the first circumferential direction. For a free-wheel mode for the one-way wedge clutch, the inner race is rotatable with respect to the outer race in the first circumferential direction. For a locked mode for the one-way wedge clutch, the inner and outer races are non-rotatably connected. To transition from the free-wheel mode to the locked mode the inner race is arranged to receive torque in the first circumferential direction and the plurality of wedge plate segments is arranged to displace radially outward to non-rotatably connect with the inner and outer races.

### BRIEF DESCRIPTION OF THE DRAWINGS

Various embodiments are disclosed, by way of example only, with reference to the accompanying schematic drawings in which corresponding reference symbols indicate corresponding parts, in which:

FIG. 1 is a perspective view of a cylindrical coordinate system demonstrating spatial terminology; and,

FIG. 2 is a back perspective view of a bi-directional clutch with wedge plate segments;

FIG. 3 is a front exploded view of the bi-directional clutch shown in FIG. 2;

FIG. 4 is a front view of the bi-directional clutch shown in FIG. 2;

FIG. 5 is a cross-sectional view generally along line 5-5 in FIG. 4;

FIG. 6 is a front view of the wedge plate assembly shown in FIGS. 2 and 3;

FIG. 7 is a schematic block diagram of the bi-directional clutch shown in FIG. 2 with an actuator;

FIG. 8 is a front view of an example wedge plate assembly for a bi-directional clutch;

FIG. 9 is a front view of an example wedge plate assembly for a bi-directional clutch;

FIG. 10 is a front view of an example wedge plate assembly for a bi-directional clutch;

FIG. 11 is a front view of an example wedge plate assembly for a bi-directional clutch;

FIG. 12 is an exploded view of a one-way clutch with wedge plate segments;

FIG. 13 is a front view of an example wedge plate assembly for a one-way clutch with wedge plate segments; and,

FIG. 14 is a front view of a prior art wedge plate.

### DETAILED DESCRIPTION

At the outset, it should be appreciated that like drawing numbers on different drawing views identify identical, or functionally similar, structural elements. It is to be understood that the claims are not limited to the disclosed aspects.

Furthermore, it is understood that this disclosure is not limited to the particular methodology, materials and modifications described and as such may, of course, vary. It is also understood that the terminology used herein is for the purpose of describing particular aspects only, and is not intended to limit the scope of the claims.

Unless defined otherwise, all technical and scientific terms used herein have the same meaning as commonly understood to one of ordinary skill in the art to which this disclosure pertains. It should be understood that any methods, devices or materials similar or equivalent to those described herein can be used in the practice or testing of the example embodiments.

It should be appreciated that the term “substantially” is synonymous with terms such as “nearly,” “very nearly,” “about,” “approximately,” “around,” “bordering on,” “close to,” “essentially,” “in the neighborhood of,” “in the vicinity of,” etc., and such terms may be used interchangeably as appearing in the specification and claims. It should be appreciated that the term “proximate” is synonymous with terms such as “nearby,” “close,” “adjacent,” “neighboring,” “immediate,” “adjoining,” etc., and such terms may be used interchangeably as appearing in the specification and claims. The term “approximately” is intended to mean values within ten percent of the specified value.

By “non-rotatably connected” elements, we mean that: the elements are connected so that whenever one of the elements rotate, all the elements rotate; and relative rotation between the elements is not possible. Radial and/or axial movement of non-rotatably connected elements with respect to each other is possible, but not required.

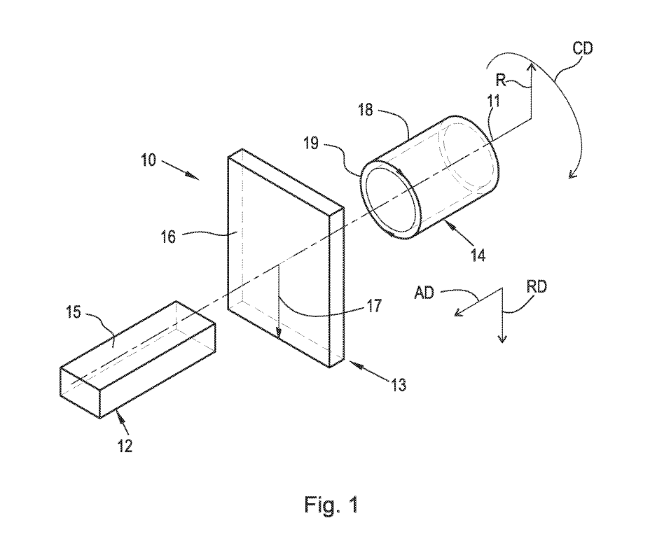

FIG. 1 is a perspective view of cylindrical coordinate system 10 demonstrating spatial terminology. The present application is at least partially described within the context of a cylindrical coordinate system. System 10 includes longitudinal axis 11, used as the reference for the directional and spatial terms that follow. Axial direction AD is parallel to axis 11. Radial direction RD is orthogonal to axis 11. Circumferential direction CD is defined by an endpoint of radius R (orthogonal to axis 11) rotated about axis 11.

To clarify the spatial terminology, objects 12, 13, and 14 are used. An axial surface, such as surface 15 of object 12, is formed by a plane co-planar with axis 11. Axis 11 passes through planar surface 15; however any planar surface co-planar with axis 11 is an axial surface. A radial surface, such as surface 16 of object 13, is formed by a plane orthogonal to axis 11 and co-planar with a radius, for example, radius 17. Radius 17 passes through planar surface 16; however any planar surface co-planar with radius 17 is a radial surface. Surface 18 of object 14 forms a circumferential, or cylindrical, surface. For example, circumference 19 passes through surface 18. As a further example, axial movement is parallel to axis 11, radial movement is orthogonal to axis 11, and circumferential movement is parallel to circumference 19. Rotational movement is with respect to axis 11. The adverbs “axially,” “radially,” and “circumferentially” refer to orientations parallel to axis 11, radius 17, and circumference 19, respectively. For example, an axially disposed surface or edge extends in direction AD, a radially disposed surface or edge extends in direction R, and a circumferentially disposed surface or edge extends in direction CD.

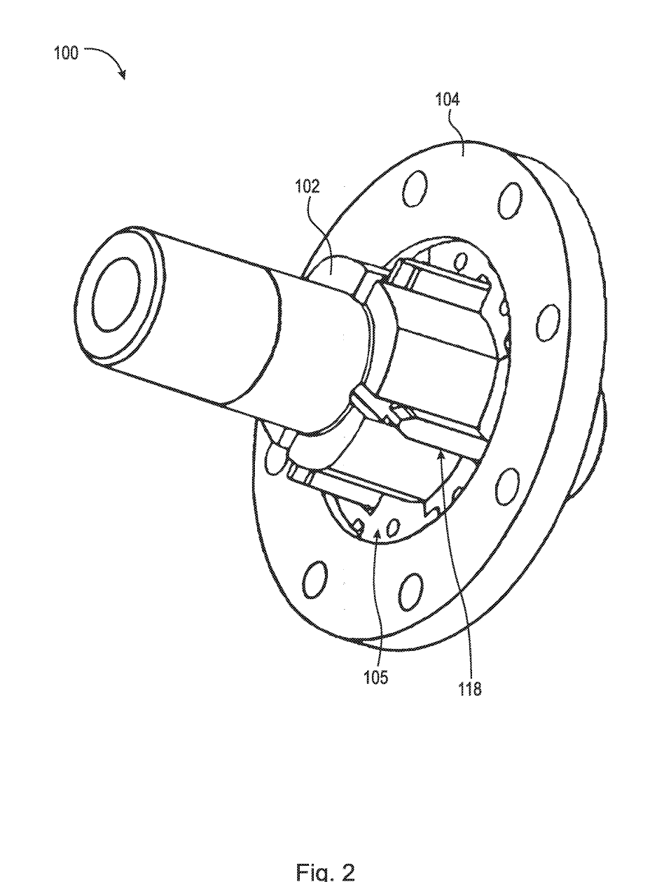

FIG. 2 is a hack perspective view of bi-directional clutch 100 with wedge plate segments.

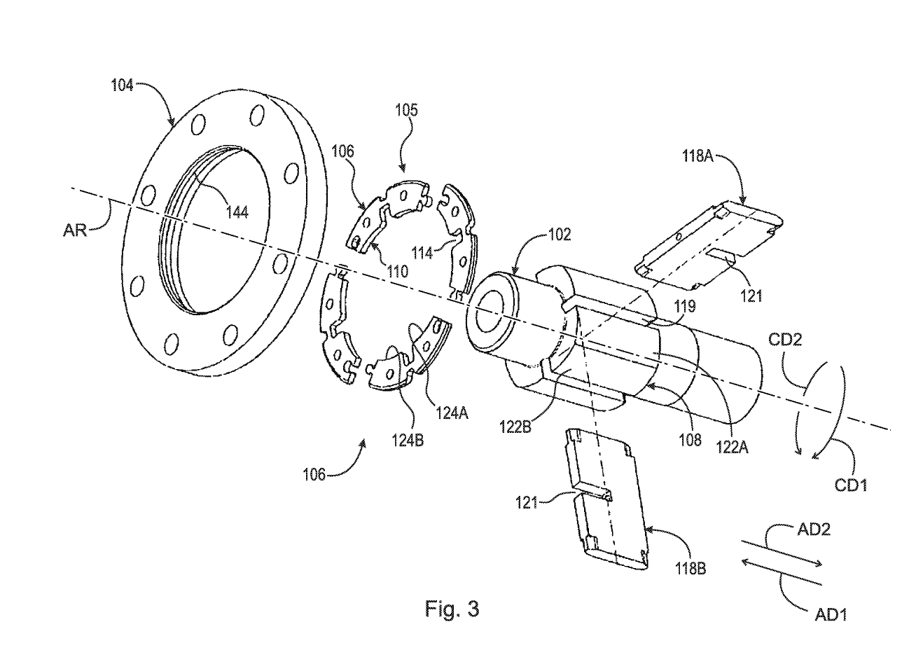

FIG. 3 is a front exploded view of bi-directional clutch shown 100 in FIG. 2. The following should be viewed in light of FIGS. 2 and 3. Clutch 100 includes: axis of rotation AR; inner race 102 arranged to receive torque; outer race 104 located radially outward of the inner race; and wedge plate assembly 105, including wedge plate segments 106, disposed between races 102 and 104 in radial direction RD orthogonal to axis AR. Race 102 includes radially outwardly extending ramps 108. Each wedge plate segment 106: is formed of a separate piece of material; and includes at least one radially inwardly extending ramp 110 in contact with at least one respective ramp 108.

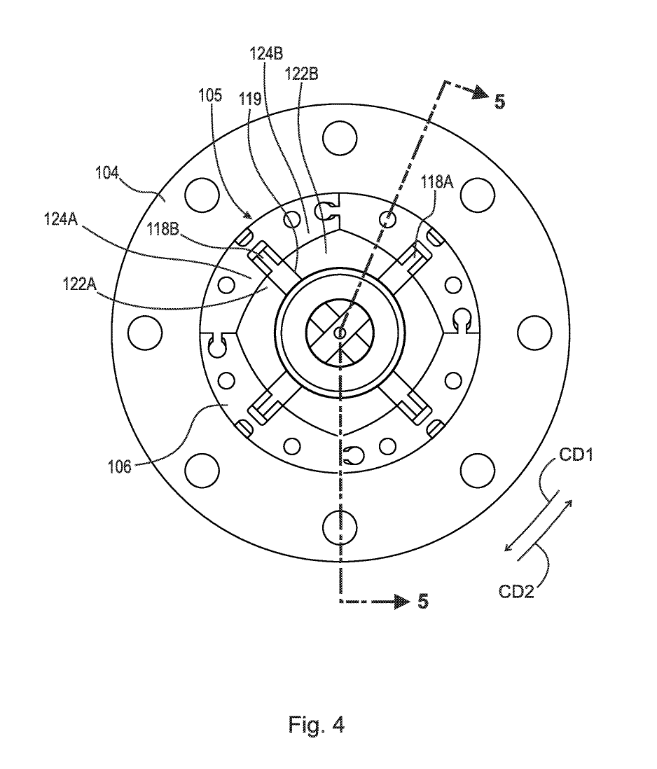

FIG. 4 is a front view of clutch 100 shown in FIG. 2.

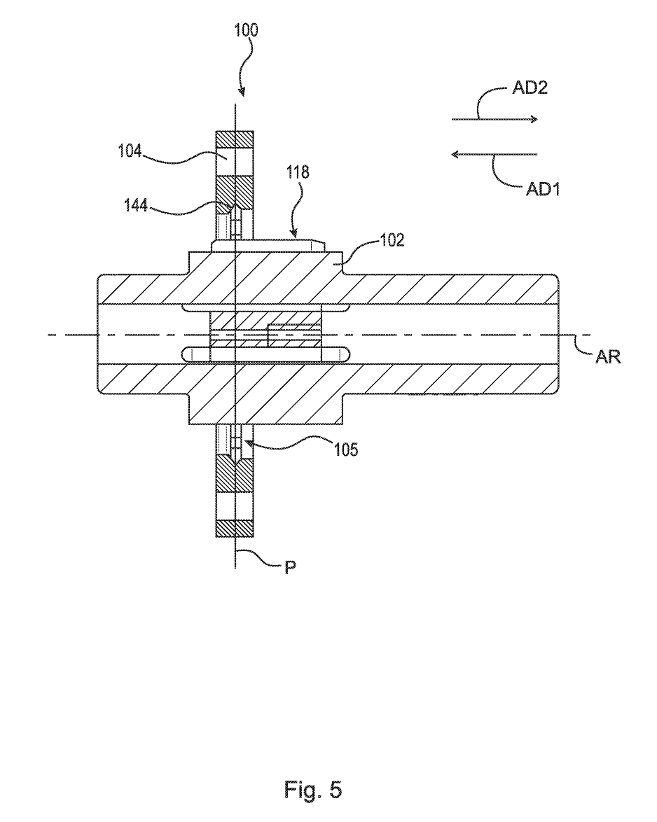

FIG. 5 is a cross-sectional view generally along line 5-5 in FIG. 4.

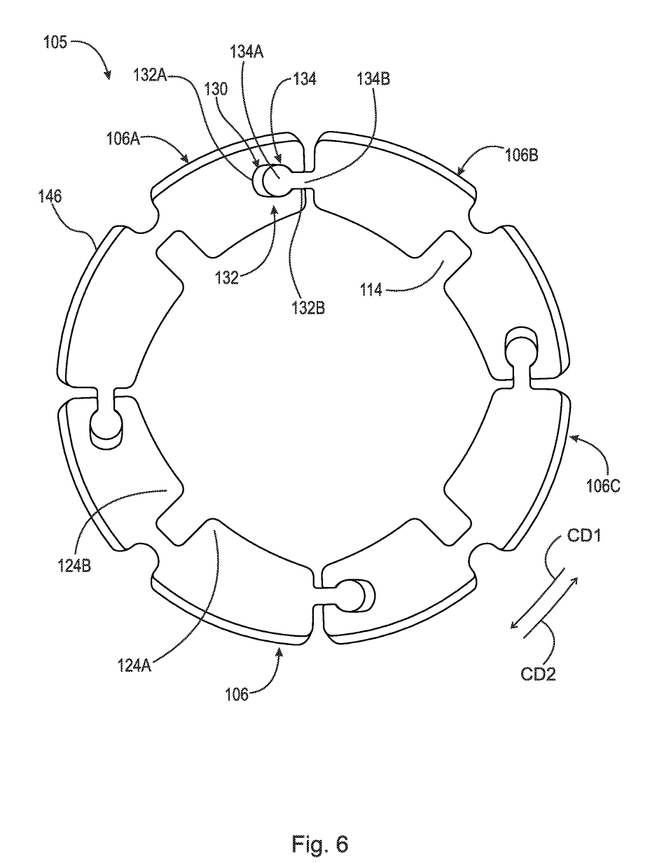

FIG. 6 is a front view of wedge plate assembly 105 shown in FIGS. 2 and 3. The following should be viewed in light of FIGS. 2 through 6. In FIG. 6, assembly 105 is expanded radially outward and circumferentially adjacent segments 106 have displaced from each other. Wedge plate segments 106 are aligned in opposite circumferential directions CD1 and CD2. For example, plane P orthogonal to axis of rotation AR passes through wedge plate segments 106. Axis of rotation AR passes through plane P at only one point on axis AR.

For an open mode for wedge clutch 100: inner race 102 is at least limitedly rotatable with respect to outer race 104; and wedge plate segments 106 are at least limitedly rotatable with respect to outer race 104. As described below, the open mode is present when torque is not applied to race 102, for example to transition between locked modes. To transition from the open mode to a first locked mode for the wedge clutch: inner race 102 is arranged to receive torque in circumferential direction CD1 and assembly 105 is arranged to displace radially outward to non-rotatably connect with races 102 and 104. At least some circumferentially adjacent wedge plate segments 106 are arranged to displace away from each other in circumferential directions CD1 or CD2. For example, segment 106A can displace from segment 106B in direction CD2 and segment 106C can displace from segment 106B in direction CD1. It is possible for all the circumferentially adjacent wedge plate segments 106 to displace away from each other in circumferential directions CD1 or CD2.

To transition from the open mode to a second locked mode for wedge clutch 100: inner race 102 is arranged to receive torque in circumferential direction CD2; assembly 105 is arranged to displace radially outward to non-rotatably connect with races 102 and 104; and at least some circumferentially adjacent wedge plate segments 106 are arranged to displace away from each other in circumferential directions CD1 or CD2. It is possible for all the circumferentially adjacent wedge plate segments 106 to displace away from each other in circumferential directions CD1 or CD2.

To transition from the first locked mode to the open mode, torque is removed from race 102 and assembly 105 is arranged to displace radially inward to enable rotation between races 102 and 104. At least some of the circumferentially adjacent wedge plate segments 106, which had displaced circumferentially away from each other in the first locked mode, displace toward each other in circumferential directions CD1 or CD2. For example, segment 106A can displace toward segment 106B in direction CD1 and segment 106C can displace toward segment 106B in direction CD2. Stated otherwise, segments 106 collapse radially inward when the torque is removed from race 102.

To transition from the second locked mode to the open mode, torque is removed from race 102 and assembly 105 is arranged to displace radially inward to enable rotation between races 102 and 104. At least some of the circumferentially adjacent wedge plate segments 106, which had displaced circumferentially away from each other in the second locked mode, displace toward each other in circumferential directions CD1 or CD2. For example, segment 106A can displace toward segment 106B in direction CD1 and segment 106C can displace toward segment 106B in direction CD2. Stated otherwise, segments 106 collapse radially inward when the torque is removed from race 102.

It should be understood that the circumferential displacement between adjacent segments 106 can be a combination of circumferential displacement of both adjacent segments. For example, to transition from the open or free-wheel mode to the first locked mode, segment 106A can displace from segment 106B in direction CD2 and segment 106B can simultaneously displace from segment 106A in direction CD1.

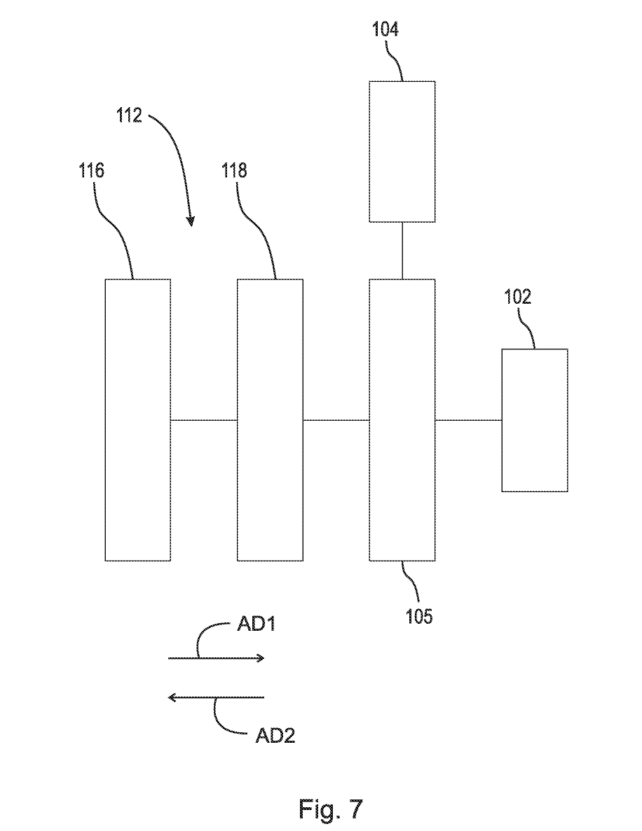

FIG. 7 is a schematic block diagram of bi-directional clutch 100 shown in FIG. 2 with an actuator. The following should be viewed in light of FIGS. 2 through 7. Clutch 100 includes actuation assembly 112. Each wedge plate segment 106 includes slot 114. For the open mode, actuation assembly 112 is arranged to engage wedge plate segments 106 to limit rotation of wedge plate segments 106 with respect inner race 102. For the first and second locked modes, actuation assembly 112 is arranged to disengage from wedge plate segments 106.

In an example embodiment, actuation assembly 112 includes actuator 116 and blocking plates 118 non-rotatably connected to inner race 102. For the open mode: actuator 116 is arranged to displace blocking plates 118 in axial direction AD1 into slots 114; and blocking plates 118 are arranged to limit circumferential displacement of wedge plate segments 106 with respect to inner race 102. To transition from the open mode to the first locked mode: inner race 102 is arranged to receive torque in circumferential direction CD1; actuator 116 is arranged to displace blocking plates 118 in axial direction AD2, opposite axial direction AD1, to withdraw blocking plates 118 from slots 114; and inner race 102 is arranged to rotate with respect to wedge plate segments 106.

To transition from the open mode to the second locked mode: inner race 102 is arranged to receive torque in circumferential direction CD2; actuator 116 is arranged to displace blocking plates 118 in axial direction AD2 to withdraw blocking plates 118 from slots 114; and inner race 102 is arranged to rotate with respect to wedge plate segments 106.

In an example embodiment, blocking plates 118 includes plates 118A and 118B: disposed in slots 119 in race 102; and connected to each other with slots 121. It should be understood that other configurations for plates 118 are possible.

In the example embodiment shown in FIGS. 2 and 3: ramps 108 include respective pairs of radially outwardly extending ramps 122A and 122B; and each at least one radially inwardly extending ramp 110 includes radially inwardly extending ramps 124A and 124B in contact with ramps 122A and 122B. To transition from the open mode to the first locked mode, each ramp 122A is arranged to slide up a respective ramp 124A to displace wedge plate segments 106 radially outward to non-rotatably connect wedge plate segments 106 with races 102 and 104. To transition from the open mode to the second locked mode, each ramp 122B is arranged to slide up a respective ramp 124B to displace wedge plate segments 106 radially outward to non-rotatably connect wedge plate segments 106 with races 102 and 104.

To transition from the first locked mode to the open mode, each ramp 122A is arranged to slide down a respective ramp 124A so that assembly 105 contracts radially inward and the non-rotatable connection of wedge plate segments 106 and outer race 104 is disrupted. To transition from the second locked mode to the open mode, each ramp 122B is arranged to slide down a respective ramp 124B so that assembly 105 contract radially inward and the non-rotatable connection of wedge plate segments 106 and outer race 104 is disrupted.

In an example embodiment, a wedge plate segment 106 is connected to circumferentially adjacent wedge plate segments 106. For example, segment 106B is connected to segments 106A and 106C. For example, the connection shown for wedge plate segment 106B to circumferentially adjacent wedge plate segments 106A and 106C: enables the circumferentially adjacent wedge plate segments 106A and 106C to circumferentially displace toward and away from wedge plate segment 106B; and limits an amount by which the circumferentially adjacent wedge plate segments 106A and 106C are circumferentially displaceable away from wedge plate segment 106B.

In an example embodiment, assembly 105 includes connecting assemblies 130 for at least some of wedge plate segments 106. Each assembly 130 includes slot 132 in one segment 106 and protrusion 134, extending from a circumferentially adjacent segment 106, disposed in a respective slot 132. In the example embodiment of FIG. 6, each protrusion 134 includes: bulb portion 134A disposed in portion 132A of a respective slot 132; and neck portion 134B disposed in portion 132B of the respective slot 132. Bulb portion 134A is larger, in particular in direction RD, than portion 132B; therefore, portion 132B traps bulb portion 134A in portion 132A. A circumferential extent of portion 132A is greater than a circumferential extent of bulb portion 134A. Therefore, the segment 106 including a slot 132 and the segment 106 including the protrusion 134, disposed in the slot 132, are circumferentially displaceable with respect to each other. In FIG. 6, assembly 105 is radially expanded and bulb portion 134A is restrained from further movement in direction CD1 by neck portion 132B.

Assemblies 130 in FIG. 6 enable radial expansion and contraction of assembly 105. For example: displacement of wedge plate segments 106 circumferentially away from each other results in radial expansion of assembly 105; and displacement of wedge plate segments 106 circumferentially toward each other results in radial contraction of assembly 105. Assemblies 130 maintain a connection between adjacent segments 106 during radial and circumferential expansion and contraction of assembly 105, for example, limiting amount by which adjacent segments 106 can displace from each other in a circumferential direction.

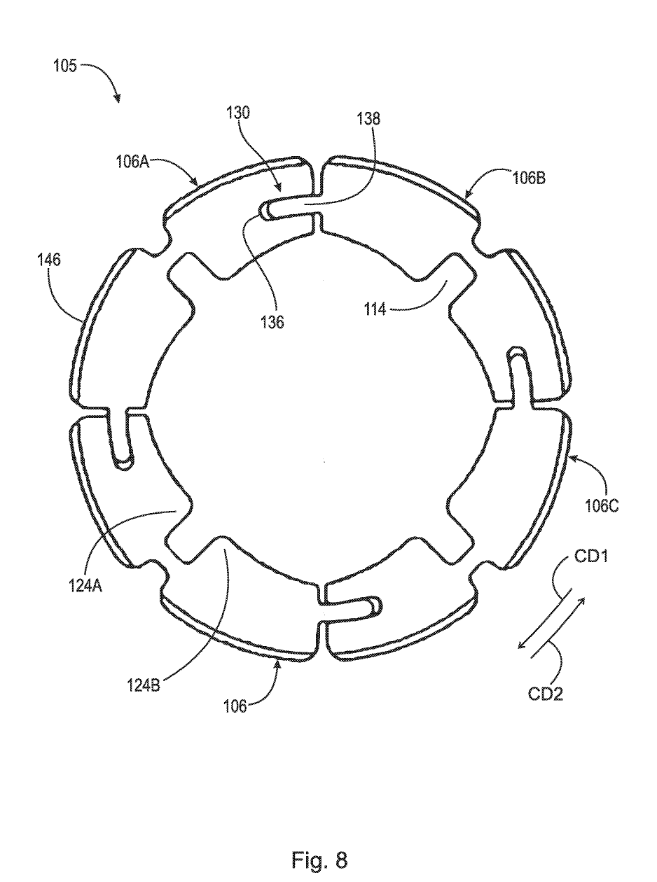

FIG. 8 is a front view of an example wedge plate assembly 105 for bi-directional clutch 100. In FIG. 8, assembly 105 is expanded radially outward and circumferentially adjacent segments 106 have displaced from each other. In the example embodiment of FIG. 8, each assembly 130 includes slot 136 in one segment 106 and protrusion 138, extending from a circumferentially adjacent segment 106, disposed in a respective slot 132. The segment 106 including a slot 136 and the segment 106 including the protrusion 138, disposed in the slot 136, are circumferentially displaceable with respect to each other. For example, segments 106A and 106B are circumferentially displaceable with respect to each other. Assemblies 130 in FIG. 8 enable radial expansion and contraction of wedge plate segments 106. For example: displacement of wedge plate segments 106 circumferentially away from each other results in radial expansion of assembly 105; and displacement of wedge plate segments 106 circumferentially toward each other results in radial contraction of assembly 105. Assemblies 130 control radial and circumferential expansion and contraction of segments 106, for example, segments 106 are kept at a substantially equal radial distance from axis AR by protrusions 138 and slots 136. That is, protrusion 138 and slots 136 do not restrict circumferential movement between adjacent segments 106, but limit radial movement between adjacent segments 106.

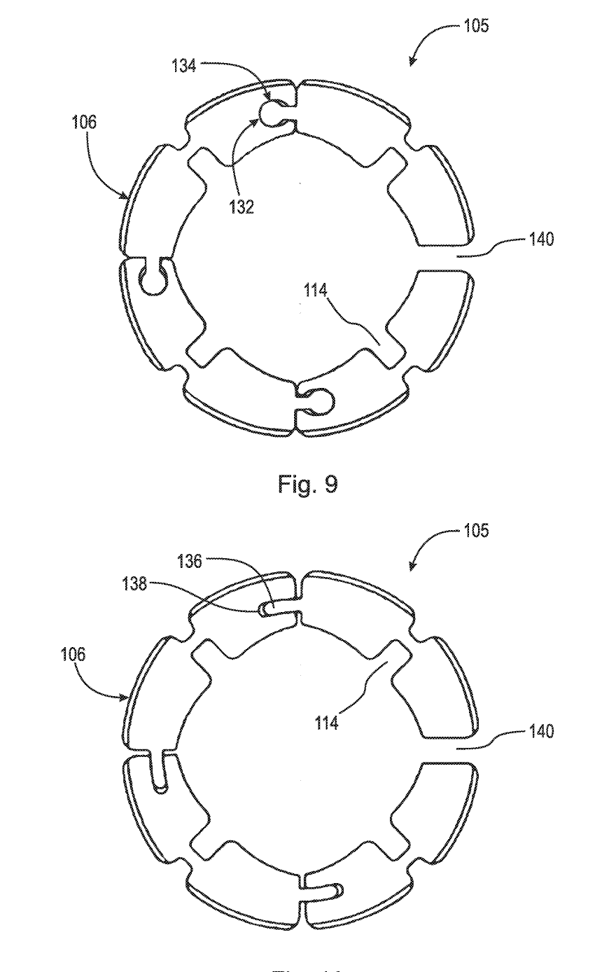

FIG. 9 is a front view of an example wedge plate assembly 105 for bi-directional clutch 100.

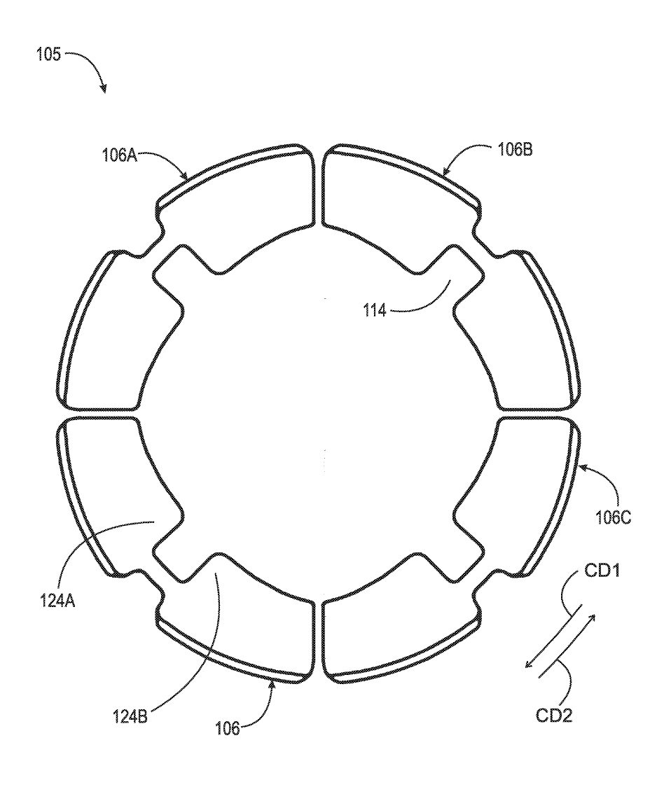

FIG. 10 is a front view of an example wedge plate assembly 105 for bi-directional clutch 100. FIGS. 9 and 10 are example variations of wedge plate segments 106 shown in FIGS. 6 and 8, respectively. In FIGS. 9 and 10 gap 140 is present between two circumferentially adjacent segments 106. In FIG. 9, assembly 105 is contracted radially inward and circumferentially adjacent segments 106 have displaced toward each other. In FIG. 10, assembly 105 is expanded radially outward and circumferentially adjacent segments 106 have displaced from each other.

FIG. 11 is a front view of an example wedge plate assembly 105 for bi-directional clutch 100. In FIG. 11, wedge plate segments 106 are not connected to each other with respective assemblies 130, which simplifies the fabrication of segments 106 and the assembly of clutch 100. Thus, at least some of segments 106 are free of contact with circumferentially adjacent segments 106. For example, in the first locked mode, segment 106B can be free of contact with one or both of segments 106A and 106C. In FIG. 11, assembly 105 is expanded radially outward and circumferentially adjacent segments 106 have displaced from each other.

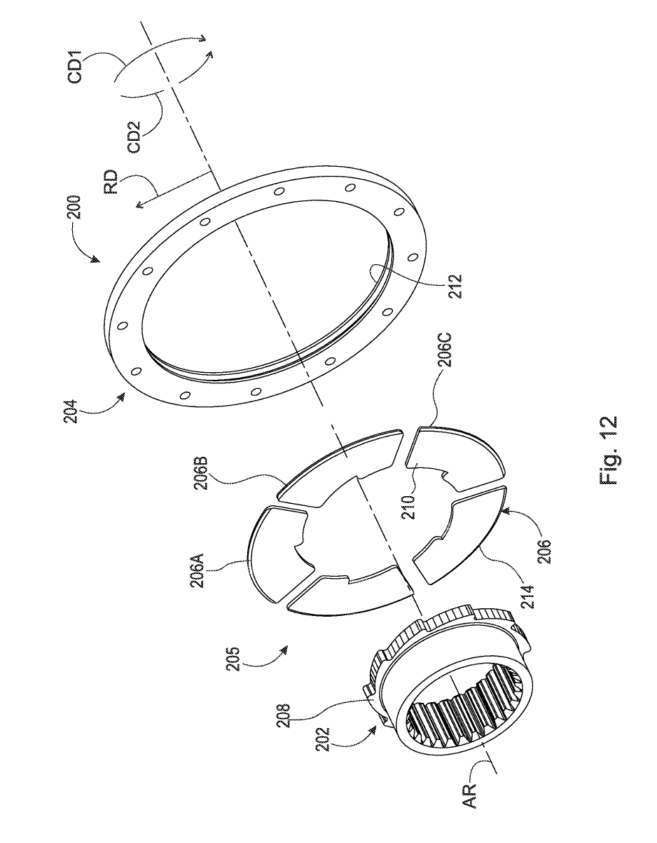

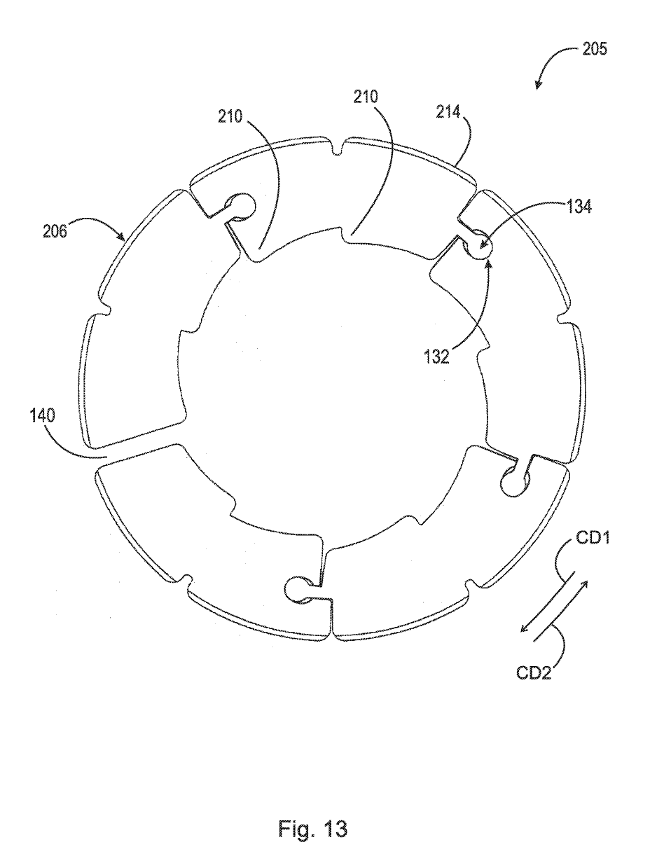

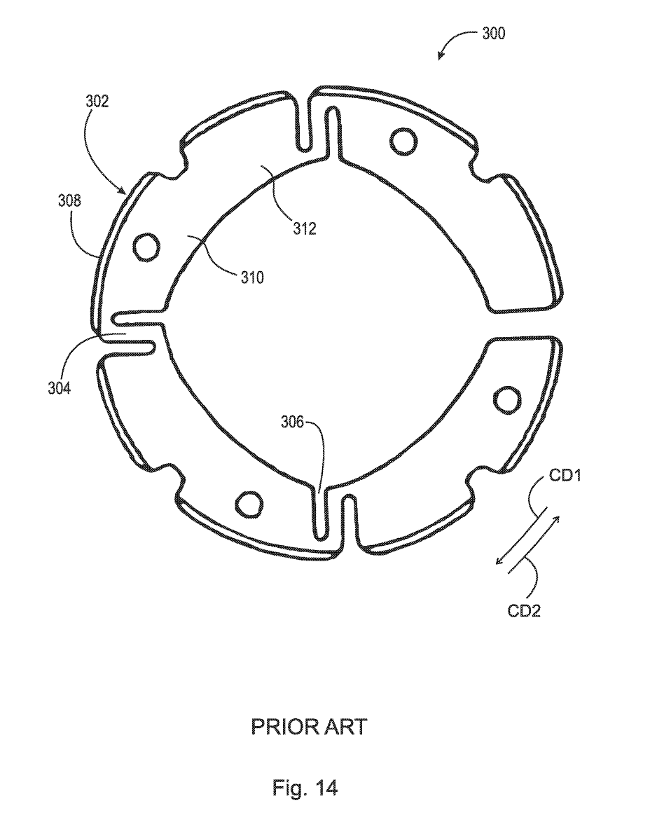

FIG. 12 is a perspective view of one-way clutch 200 with wedge plate segments.

Clutch 200 includes: axis of rotation AR; inner race 202 arranged to receive torque; outer race 204 located radially outward of the inner race; and wedge plate assembly 205, including wedge plate segments 206, disposed between races 202 and 204 in radial direction RD orthogonal to axis AR. Race 202 includes radially outwardly extending ramps 208. Each wedge plate segment 206: is formed of a separate piece of material; and includes at least one radially inwardly extending ramp 210 in contact with at least one respective ramp 208. Wedge plate segments 206 are aligned in opposite circumferential directions CD1 and CD2. In an example embodiment, each segment 206 includes two ramps 210.

In FIG. 12, wedge plate segments 206 are not directly connected to each other, which simplifies the fabrication of segments 206 and the assembly of clutch 200. Thus, at least some of segments 206 are free of contact with circumferentially adjacent segments 206. For example, in a locked mode for clutch 200 described below, segment 206B can be free of contact with one or both of segments 206A and 206C.

In a free-wheel mode for one-way clutch 200, inner race 202 is rotatable with respect to outer race 204, for example in circumferential direction CD1. For the locked mode for clutch 200, rotation of race 202, with respect to race 204, in circumferential direction CD2 is blocked by a non-rotatable connection of wedge plate segments 206 with races 202 and 204.

In an example embodiment: radially outwardly extending ramps 208 extend radially outwardly along circumferential direction CD1; and ramps 210 extending radially inward in direction CD2. To transition from the locked mode to the free-wheel mode, ramps 208 are arranged to slide along ramps 210 in circumferential direction CD1 so that the non-rotatable connection of wedge plate segments 206 and race 204 is disrupted. To transition from the free-wheel mode to the locked mode, ramps 208 are arranged to slide along ramps 210 in circumferential direction CD2 to displace wedge plate segments 206 radially outward to non-rotatably connect wedge plate segments 106 to races 102 and 104.

FIG. 13 is a front view of example wedge plate assembly 205 for one-way clutch 200. In FIG. 13, assembly 205 is contracted radially inward and circumferentially adjacent segments 206 have displaced toward each other. In the example of FIG. 13, segments 206 are joined by assemblies 130 and the discussion for assemblies 130 is applicable to assembly 205. It should be understood that the configuration of assemblies 130 in FIG. 8 can be used for segments 206.

In an example embodiment: outer race 104 includes radially inwardly facing groove 144 and each segment 106 includes chamfered radially outermost surface 146 disposed in groove 144. During the open mode, there is nominal frictional contact between surfaces 146 and the surfaces of groove 144. The nominal frictional contact results in nominal drag between segments 106 and the surface of groove 144, but does provide sufficient drag to enable race 102 to rotate with respect to segments 106 during the transition from the open mode to the first or second locked mode.

In an example embodiment: outer race 204 includes radially inwardly facing groove 212 and each segment 206 includes chamfered radially outermost surface 214 disposed in groove 212. During the free-wheel mode, there is nominal frictional contact between surfaces 214 and the surface of groove 212. The nominal frictional contact results in nominal drag between segments 206 and the surface of groove 212, but does provide sufficient drag to enable race 202 to rotate with respect to segments 206 during the transition from the free-wheel mode to the locked mode.

Advantageously, clutches 100 and 200 and wedge plate assemblies 105 and 205 address the problems noted above. Because assemblies 105 and 205 are made up of separate wedge plate segments 106 and 206, respectively, there is no need to provide the radial biasing required for a monolithic wedge plate. For example, connections 130 or the configuration of FIGS. 11 and 12 enable assemblies 105 and 205 to radially expand and contract and segments 106 and 206 to circumferentially displace as needed for the open, free-wheel and locked modes described above, in response to the rotation of races 102 and 202. Thus, there is no need to limit the axial thickness of segments 106 or 206 and there is no need to use more expensive spring steel or similar material for assembly 105 or 205.

It will be appreciated that various aspects of the disclosure above and other features and functions, or alternatives thereof, may be desirably combined into many other different systems or applications. Various presently unforeseen or unanticipated alternatives, modifications, variations, or improvements therein may be subsequently made by those skilled in the art which are also intended to be encompassed by the following claims.

1-20. (canceled)

21. A wedge clutch, comprising:
an inner race arranged to receive torque and including a plurality of radially outwardly extending ramps;
an outer race located radially outward of the inner race; and,
a wedge plate assembly, including a plurality of wedge plate segments, disposed between the inner and outer races in a radial direction, each wedge plate segment:
is formed of a separate piece of material; and,
includes at least one radially inwardly extending ramp in contact with at least one respective ramp included in the plurality of radially outwardly extending ramps, wherein:
wedge plate segments in the plurality of wedge plate segments are aligned in first and second opposite circumferential directions;
for an open mode or a free-wheel mode for the wedge clutch, the plurality of wedge plate segments is rotatable with respect to the outer race; and,
to transition from the open or free-wheel mode to a first locked mode for the wedge clutch:
the inner race is arranged to receive torque in a first circumferential direction;
the plurality of wedge plate segments is arranged to displace radially outward to non-rotatably connect with the inner and outer races.

22. The wedge clutch of claim 21, wherein to transition from the open or free-wheel mode to the first locked mode, first and second circumferentially adjacent wedge plate segments are arranged to displace away from each other in the first or second circumferential direction.

23. The wedge clutch of claim 21, wherein to transition from the open mode to a second locked mode for the wedge clutch:
the inner race is arranged to receive torque in the second circumferential direction;
first and second circumferentially adjacent wedge plate segments are arranged to displace away from each other in the first or second circumferential direction; and,
the plurality of wedge plate segments is arranged to displace radially outward to non-rotatably connect with the inner and outer races.

24. The wedge clutch of claim 21, wherein to transition from the first locked mode to the open or free-wheel mode:
first and second circumferentially adjacent wedge plate segments are arranged to displace toward each other in the first or second circumferential direction; and,
the wedge plate assembly is arranged to contract radially inward to enable rotation between the inner and outer races.

25. The wedge clutch of claim 21, further comprising:
an actuation assembly, wherein:
for the open mode, the actuation assembly is arranged to engage the plurality of wedge plate segments to limit rotation of the plurality of wedge plate segments with respect to the inner race; and,
for the first locked mode, the actuation assembly is arranged to disengage from the plurality of wedge plate segments.

26. The wedge clutch of claim 25, wherein:
each wedge plate segment includes a respective slot;
the actuation assembly includes:
a plurality of blocking plates non-rotatably connected to the inner race; and,
an actuator; and,
for the open mode:
the actuator is arranged to displace the plurality of blocking plates in a first axial direction into the respective slots; and,
the plurality of blocking plates is arranged to limit the circumferential displacement of the plurality of wedge plate segments with respect to the inner race.

27. The wedge clutch of claim 26, wherein to transition from the open mode to the first locked mode:
the inner race is arranged to receive torque in the first circumferential direction;
the actuator is arranged to displace the plurality of blocking plates in a second axial direction opposite the first axial direction to withdraw the plurality of blocking plates from the respective slots; and,
the inner race is arranged to rotate with respect to the plurality of wedge plate segments.

28. The wedge clutch of claim 26, wherein:
in a second locked mode for the wedge clutch, the inner race, the plurality of wedge plate segments, and the outer race are non-rotatably connected; and,
to transition from the open mode to the second locked mode:
the inner race is arranged to receive torque in the second circumferential direction;
the actuator is arranged to displace the plurality of blocking plates in a second axial direction opposite the first axial direction to withdraw the plurality of blocking plates from the respective slots; and,
the inner race is arranged to rotate with respect to the plurality of wedge plate segments.

29. The wedge clutch of claim 21, wherein:
the plurality of radially outwardly extending ramps includes respective pairs of first and second radially outwardly extending ramps;
the at least one radially inwardly extending ramp includes first and second radially inwardly extending ramps in contact with the first and second radially outwardly extending ramps, respectively, for a respective pair;
to transition from the open mode to the first locked mode, the first radially outwardly extending ramp for the respective pair is arranged to slide along the respective first radially inwardly extending ramp to displace the plurality of wedge plate segments radially outward; and,
to transition from the first locked mode to the open mode, the first radially outwardly extending ramp for the respective pair is arranged to slide along the respective first radially inwardly extending ramp so that the plurality of wedge plate segments contracts radially inward.

30. The wedge clutch of claim 21, wherein:
in the free-wheel mode, the inner race is rotatable with respect to the outer race in the second circumferential direction;
each ramp in the plurality of radially outwardly extending ramps extends radially outwardly along the second circumferential direction;
the at least one radially inwardly extending ramp extends radially inwardly along the first circumferential direction;
to transition from the first locked mode to the free-wheel mode, the plurality of radially outwardly extending ramps is arranged to slide along the at least one radially inwardly extending ramps in the second circumferential direction; and,
to transition from the free-wheel mode to the first locked mode, the plurality of radially outwardly extending ramps is arranged to slide along the respective radially inwardly extending ramps in the first circumferential direction.

31. The wedge clutch of claim 21, wherein:
a first wedge plate segment is directly adjacent to a second wedge plate segment in the first circumferential direction;
the first wedge plate segment includes one of a first circumferentially extending protrusion or a first slot; and,
the second wedge plate segment includes:
a second slot into which at least a portion of the first circumferentially extending protrusion is disposed; or,
a second circumferentially extending protrusion including at least a portion disposed in the first slot.

32. The wedge clutch of claim 21, wherein:
a first wedge plate segment is directly adjacent to a second wedge plate segment in the first circumferential direction;
a third wedge plate segment is directly adjacent to the second wedge plate segment in the second circumferential direction; and,
in the first locked mode, the second wedge plate segment is free of contact with at least one of the first or third wedge plate segment.

33. A bi-directional wedge clutch, comprising:
an inner race arranged to receive torque;
an outer race located radially outward of the inner race;
a wedge plate assembly including a plurality of wedge plate segments disposed between the inner and outer races in a radial direction, each wedge plate segment formed of a separate piece of material; and,
an actuation assembly including:
a plurality of blocking plates non-rotatably connected to the inner race; and,
an actuator, wherein:
wedge plate segments in the plurality of wedge plate segments are aligned in first and second opposite circumferential directions;
for an open mode for the bi-directional wedge clutch, the plurality of blocking plates is arranged to limit rotation of the plurality of wedge plate segments with respect to the inner race; and,
to transition from the open mode to a first locked mode for the bi-directional wedge clutch:
the actuator is arranged to axially displace the plurality of blocking plates in a first axial direction;
the plurality of blocking plates is arranged to disengage from the plurality of wedge plate segments;
the inner race is arranged to receive torque in a first circumferential direction; and,
the plurality of wedge plate segments is arranged to displace radially outward to non-rotatably connect with the inner and outer races.

34. The bi-directional wedge clutch of claim 33, wherein to transition from the open mode to the first locked mode, first and second circumferentially adjacent wedge plate segments are arranged to displace away from each other in the first or second circumferential direction.

35. The bi-directional wedge clutch of claim 33, wherein:
each wedge plate segment includes a respective slot;
in the open mode, the inner and outer races are free of a non-rotatable connection; and,
to transition from the first locked mode to the open mode:
the wedge plate assembly is arranged to contract circumferentially and radially;
the actuator is arranged to displace the plurality of blocking plates in a second axial direction opposite the first axial direction; and,
the plurality of blocking plates is arranged to displace into the respective slots to limit circumferential displacement of the plurality of wedge plate segments with respect to the inner race.

36. The bi-directional wedge clutch of claim 33, wherein to transition from the open mode to the first locked mode:
the inner race is arranged to receive torque in the first circumferential direction;
the actuator is arranged to displace the plurality of blocking plates in the first axial direction to withdraw the plurality of blocking plates from the respective slots; and,
the inner race is arranged to rotate with respect to the plurality of wedge plate segments.

37. The bi-directional wedge clutch of claim 33, wherein:
the inner race includes a plurality of pairs of first and second radially outwardly extending ramps;
said each wedge plate segment includes respective first and second radially inwardly extending ramps engaged with the first and second radially outwardly extending ramps for a respective pair;
to transition from the open mode to the first locked mode, the first radially outwardly extending ramp for the respective pair is arranged to slide along the respective first radially inwardly extending ramps in the second circumferential direction to displace the plurality wedge plate segments radially outward; and,
to transition from the first locked mode to the open mode, the first radially outwardly extending ramp for the respective pair is arranged to slide along the respective first radially inwardly extending ramp in the first circumferential direction to enable the plurality of wedge plate segments to contract radially inward.

38. The wedge clutch of claim 33, wherein:
for a second locked mode for the wedge clutch, the wedge plate assembly is arranged to expand circumferentially and radially to non-rotatably connect with the inner and outer races; and,
to transition from the open mode to the second locked mode:
the actuator is arranged to axially displace the plurality of blocking plates in the first axial direction;
the plurality of blocking plates is arranged to disengage from the plurality of circumferentially aligned wedge plate segments; and,
the inner race is arranged to receive torque in the second circumferential direction.

39. A one-way wedge clutch, comprising:
an inner race arranged to receive torque and including a plurality of first ramps extending radially outward along a first circumferential direction;
an outer race located radially outward of the inner race; and,
a plurality of wedge plate segments disposed between the inner and outer races in a radial direction, each wedge plate segment:
is formed of a separate piece of material; and,
includes a second ramp extending radially inward in a second circumferential direction, opposite the first circumferential direction, and in contact with a respective first ramp, wherein:
for a free-wheel mode for the one-way wedge clutch, the inner race is rotatable with respect to the outer race in the first circumferential direction;
for a locked mode for the one-way wedge clutch, the inner and outer races are non-rotatably connected; and,
to transition from the free-wheel mode to the locked mode:
the inner race is arranged to receive torque in the first circumferential direction; and,
the plurality of wedge plate segments is arranged to displace radially outward to non-rotatably connect with the inner and outer races.

40. The one-way wedge clutch of claim 33, wherein to transition from the free-wheel mode to the locked mode, first and second circumferentially adjacent wedge plate segments are arranged to displace away from each other in the first or second circumferential direction.
